(19) United States
(12) Patent Application Publication
(10) Pub. No.: US 2025/0326109 A1
(43) Pub. Date: Oct. 23, 2025

(54) ROBOT TEACHING SYSTEM AND ROBOT TEACHING METHOD

(71) Applicant: Panasonic Intellectual Property Management Co., Ltd., Osaka (JP)

(72) Inventors: NAOMI MOCHIMARU, Osaka (JP); HIROYOSHI UEDA, Osaka (JP); KAZUKI HANADA, Osaka (JP); KAZUKI IWAO, Hyogo (JP); MIYU OISHI, Osaka (JP)

(21) Appl. No.: 19/171,394

(22) Filed: Apr. 7, 2025

(30) Foreign Application Priority Data
Apr. 19, 2024 (JP) 2024-068510

(51) Int. Cl. B25J 9/00; B25J 9/16; G06F 3/01; G06T 19/00

(52) U.S. Cl. CPC B25J 9/0081; B25J 9/1605; G06F 3/017; G06T 19/006

(57) ABSTRACT

A robot teaching system stores teaching point data corresponding to a teaching point used to display teaching data of a robot, acquires a relative positional relationship between an actual environment and a display device that displays an image to be superimposed on an image of the actual environment or the actual environment itself, generates a display image that displays the teaching point so as to have a predetermined positional relationship with respect to the display device, outputs the display image to the display device, detects an aerial operation of a worker with respect to a workpiece, and generates a display image for displaying the teaching point at a position of an intersection between a predetermined direction and a surface of the workpiece when the aerial operation indicating a predetermined direction with respect to the actual environment is executed.

### BACKGROUND

### 1. Technical Field

The present disclosure relates to a robot teaching system and a robot teaching method.

### 2. Description of the Related Art

PTL 1 discloses a method of programming a robot to perform an operation by human demonstration. The method includes: demonstrating, by a human hand, an operation on a workpiece; analyzing, by a computer, a camera image of the hand demonstrating the operation on the workpiece to create demonstration data; analyzing the camera image of a new workpiece to determine an initial position and orientation of the new workpiece; generating, by the robot, a robot motion command based on the demonstration data and the initial position and orientation of the new workpiece to cause the robot to perform the operation on the new workpiece; and performing, by the robot, the operation on the new workpiece.

### Citation List

### Patent Literature

PTL 1: Unexamined Japanese Patent Publication No. 2021-167060

### SUMMARY

An object of the present disclosure is to provide a robot teaching system and a robot teaching method that support teaching of a teaching point at a position where direct teaching is difficult using fingers of a worker, a marker pen, or the like.

The present disclosure provides a robot teaching system including: a teaching data storage unit that stores teaching data for a robot existing in an actual environment; a teaching point storage unit that stores teaching point data corresponding to a teaching point used to display the teaching data; a display device that is mountable to a worker and displays an image to be superimposed on an image of the actual environment or the actual environment itself; a positional relationship acquisition unit that acquires a relative positional relationship between the actual environment and the display device; an image generation unit that generates a display image for displaying the teaching point so as to have a predetermined positional relationship with respect to the display device based on the relative positional relationship and the teaching point data; an output unit that outputs the display image to the display device; and a detection unit that detects an aerial operation that is an operation performed on a workpiece existing in the actual environment by the worker in an air separated from the display device. In a case where an operation indicating a predetermined direction with respect to the actual environment is executed as the aerial operation, the image generation unit generates the display image for displaying the teaching point at a position of an intersection between a virtual axis along the predetermined direction and a surface of the workpiece.

Furthermore, the present disclosure provides a robot teaching system including: a model storage unit that stores a three-dimensional model of a workpiece existing in an actual environment; a teaching data storage unit that stores teaching data for a robot existing in the actual environment; a teaching point storage unit that stores teaching point data corresponding to a teaching point used to display the teaching data; a display device that is mountable to a worker and displays an image to be superimposed on an image of the actual environment or the actual environment itself; a positional relationship acquisition unit that acquires a relative positional relationship between the actual environment and the display device; an image generation unit that generates a display image for displaying the three-dimensional model and the teaching point so as to have a predetermined positional relationship with respect to the display device based on the relative positional relationship, the three-dimensional model, and the teaching point data; an output unit that outputs the display image to the display device; and a detection unit that detects an aerial operation that is an operation performed on the three-dimensional model displayed in the display device by the worker in an air separated from the display device. In a case where an operation indicating a predetermined direction with respect to the actual environment is executed as the aerial operation, the image generation unit generates the display image for displaying the teaching point at a position of an intersection between a virtual axis along the predetermined direction and a surface of the workpiece.

Furthermore, the present disclosure provides a robot teaching method performed by a system including at least one computer, the method including: storing teaching data of a robot existing in an actual environment and teaching point data corresponding to a teaching point used to display the teaching data; acquiring a relative positional relationship between the actual environment and a display device that is mountable to a worker and displays an image to be superimposed on an image of the actual environment or the actual environment itself; generating a display image for displaying the teaching point so as to have a predetermined positional relationship with respect to the display device based on the relative positional relationship and the teaching point data, and outputting the display image to the display device; detecting an aerial operation that is an operation performed by the worker in an air separated from the display device on a workpiece existing in the actual environment; and in a case where an operation indicating a predetermined direction with respect to the actual environment is executed as the aerial operation, generating the display image for displaying the teaching point at a position of an intersection between a virtual axis along the predetermined direction and a surface of the workpiece, and outputting the display image to the display device.

Furthermore, the present disclosure provides a robot teaching method performed by a system including at least one computer, the method including: storing a three-dimensional model of a workpiece existing in an actual environment, teaching data of a robot existing in the actual environment, and teaching point data corresponding to a teaching point used to display the teaching data; acquiring a relative positional relationship between the actual environment and a display device that is mountable to a worker and displays an image to be superimposed on an image of the actual environment or the actual environment itself; generating a display image for displaying the three-dimensional model and the teaching point so as to have a predetermined positional relationship with respect to the display device based on the relative positional relationship, the three-dimensional model, and the teaching point data, and outputting the display image to the display device; detecting an aerial operation that is an operation performed by the worker in an air separated from the display device on the three-dimensional model existing in the actual environment; and in a case where an operation indicating a predetermined direction with respect to the actual environment is executed as the aerial operation, generating the display image for displaying the teaching point at a position of an intersection between a virtual axis along the predetermined direction and a surface of the workpiece, and outputting the display image to the display device.

According to the present disclosure, it is possible to support teaching of a teaching point at a position where direct teaching is difficult using fingers of a worker, a marker pen, or the like.

### BRIEF DESCRIPTION OF THE DRAWINGS

FIG. 1 is a diagram illustrating an example of a welding teaching system according to an exemplary embodiment;

FIG. 2 is a diagram illustrating an internal configuration example of an MR device and a processing device;

FIG. 3 is a diagram for explaining an example of a fingertip teaching method;

FIG. 4 is a flowchart illustrating an example of a teaching procedure of a teaching position by the fingertip teaching method of the MR device in the exemplary embodiment;

FIG. 5 is a diagram for explaining an example of a remote point teaching method;

FIG. 6 is a diagram for explaining another teaching method and another correction method of the teaching position;

FIG. 7 is a diagram for explaining a first teaching example of a teaching posture;

FIG. 8 is a diagram for explaining a second teaching example of a teaching posture;

FIG. 9 is a diagram for explaining a third teaching example of a teaching posture;

FIG. 10 is a flowchart illustrating a motion procedure example of the MR device in the exemplary embodiment;

FIG. 11 is a flowchart illustrating an example of a teaching procedure by the fingertip teaching method of the MR device in the exemplary embodiment;

FIG. 12 is a flowchart illustrating an example of a teaching procedure by the remote point display method of the MR device in the exemplary embodiment;

FIG. 13 is a flowchart illustrating an example of a posture teaching processing procedure of the MR device in the exemplary embodiment;

FIG. 14 is a flowchart illustrating an example of a procedure of posture calculation processing of an MR device according to the exemplary embodiment; and

FIG. 15 is a diagram illustrating an example of a mixed reality space visually recognized by a worker.

### DETAILED DESCRIPTIONS

### Background of Present Disclosure

Conventionally, in a teaching work of teaching a welding operation at the time of welding to a welding robot as in PTL 1, there is a method of teaching a welding position using a finger of a worker, a marker pen, or the like, instead of a teaching tool (hereinafter, denoted to as “teaching tool”) resembling a welding torch included in the welding robot. However, such a teaching method has a problem that, particularly in a case where it is difficult to point the teaching position from the vicinity due to the height of the workpiece to be welded, the shape of the workpiece, the environment in which teaching is performed, or the like, the distance between the worker's finger or the marker pen and the teaching position increases, and the teaching point cannot be taught.

Therefore, in the following exemplary embodiment, a robot teaching system and a robot teaching method of supporting teaching of a teaching point at a position where direct teaching is difficult using a finger of a worker, a marker pen, or the like will be described.

Hereinafter, an exemplary embodiment in which a robot teaching system and a robot teaching method according to the present disclosure are specifically disclosed will be described in detail with reference to the drawings as appropriate. It is noted that a more detailed description than need may be omitted. For example, a detailed description of a well-known matter and a repeated description of substantially the same configuration may be omitted. This is to avoid unnecessary redundancy of the following description and to facilitate understanding of those skilled in the art. Note that the appended drawings and the following descriptions are provided for those skilled in the art to fully understand the present disclosure, and are not intended to limit the subject matter set forth in the Claims in any way.

### Outline of Welding Teaching System

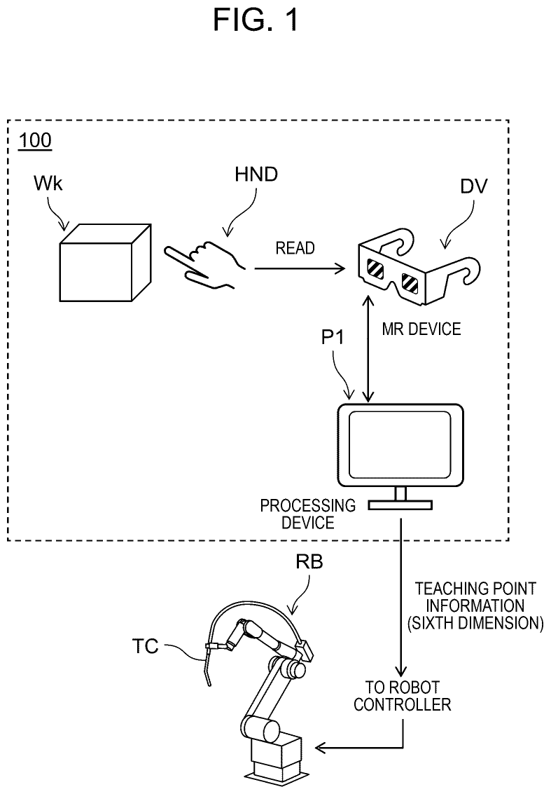

First, welding teaching system 100 according to an exemplary embodiment will be described with reference to FIG. 1. FIG. 1 is a diagram illustrating an example of welding teaching system 100 according to an exemplary embodiment. Note that welding teaching system 100 illustrated in FIG. 1 is an example, and the present disclosure is not limited thereto.

Welding teaching system 100 accepts teaching of the position and posture of the teaching point for teaching the welding operation performed by welding robot RB by hand HND of the worker or the like. Welding teaching system 100 executes the teaching of the welding operation by transmitting information of the position and posture of the teaching point taught to a robot controller that controls welding robot RB.

In the present disclosure, workpiece Wk used for teaching the teaching point may be a real workpiece or a virtual workpiece constructed based on 3D model data or the like. The welding operation described herein may include not only the welding operation for welding workpiece Wk but also an approaching operation for welding robot RB (welding torch TC) to approach workpiece Wk, an avoidance operation for welding robot RB (welding torch TC) to avoid an obstacle, an idle running operation for causing welding torch TC to idle, a separation operation for welding robot RB (welding torch TC) to separate from workpiece Wk, or the like.

Welding teaching system 100 includes workpiece Wk, MR device DV, and processing device P1. In a case where MR device DV can realize the function of processing device P1, processing device P1 may be omitted.

In the following description of the present disclosure, an example in which teaching of the teaching point is performed by hand HND of the worker will be described, but for example, a tool such as a marker pen may be used. In addition, an example in which workpiece Wk in the description of the present disclosure is not a virtual workpiece but a real workpiece will be described.

MR device DV is a so-called head mounted display, and is connected to processing device P1 in a data-communicable manner. MR device DV is mounted on the head of the worker and forms a virtual space in which an image (for example, a virtual teaching point) indicating an operation result by the worker and an image of virtual production facilities (for example, a virtual workpiece, virtual welding robot VRB, virtual welding torch VTC, a virtual jig, or the like) are superimposed on a captured image obtained by imaging a real space corresponding to the field of view of the worker and displays the virtual space on display unit 13, thereby visualizing the virtual space for the worker.

MR device DV detects hand HND of the worker or a production facility (for example, workpiece Wk, welding robot RB, a jig, or the like) from the captured image captured by camera 15. MR device DV acquires the information regarding welding robot RB transmitted from processing device P1. Note that the information regarding welding robot RB here includes the world coordinate system, the robot coordinate system of welding robot RB with respect to workpiece Wk, the coordinate system of welding torch TC, the 3D model of welding robot RB, and the like.

MR device DV accepts a registration operation of the position (three-dimensional) of the teaching point and the posture (three-dimensional) of welding torch TC for welding the teaching point based on the worker's operation. MR device DV superimposes the teaching point and the virtual production facility (for example, virtual welding robot VRB or the like) on the captured image of a real world captured by camera 15 based on the position and posture of the registered teaching point, thereby generating and displaying simulation image SC31 (see FIG. 15) for teaching the welding operation to workpiece Wk of a real world.

Processing device P1 is connected between MR device DV and the robot controller in a data-communicable manner. Processing device P1 executes the teaching processing of each teaching point by transmitting information of the position (three-dimensional) and posture (three-dimensional) of the teaching point transmitted from MR device DV to a robot controller that controls and drives the welding robot of a real world.

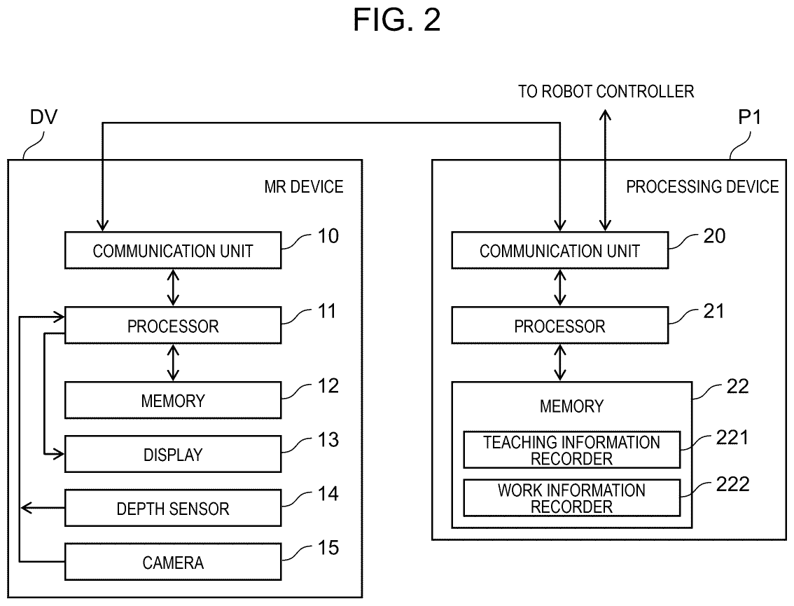

Next, an internal configuration example of MR device DV and processing device P1 will be described with reference to FIG. 2. FIG. 2 is a diagram illustrating an internal configuration example of MR device DV and processing device P1.

MR device DV includes communication unit 10, processor 11, memory 12, display unit 13, depth sensor 14, and camera 15.

Communication unit 10 is connected to processing device P1 so as to be able to perform wireless communication or wired communication, and transmits and receives data. Communication unit 10 outputs various data transmitted from processing device P1 to processor 11. Communication unit 10 transmits various data output from processor 11 to processing device P1. The wireless communication mentioned here is communication via a wireless local area network (LAN) such as Wi-Fi (registered trademark). In a case where processing device Pl is omitted in welding teaching system 100, communication unit 10 is connected to the robot controller in a data-communicable manner.

Processor 11 is configured using, for example, a central processing unit (hereinafter, referred to as “CPU”) or a field programmable gate array (hereinafter, referred to as “FPGA”), and performs various types of processing and control in cooperation with memory 12. Specifically, processor 11 refers to the program and data stored in memory 12 and executes the program to implement various functions such as a function of accepting teaching of a teaching point, a function of generating teaching information taught to welding robot RB, and a function of generating simulation image SC31 (see FIG. 15). In a case where processing device P1 is omitted in welding teaching system 100, processor 11 is configured to be able to realize the same function as processor 21 of processing device P1.

Memory 12 includes, for example, a random access memory (hereinafter, referred to as “RAM”) as a work memory used when each processing of processor 11 is executed, and a read only memory (hereinafter, referred to as “ROM”) that stores a program and data defining each operation of processor 11. Data or information generated or acquired by processor 11 is temporarily stored in the RAM. A program that defines the operation of processor 11 is written to the ROM.

Display unit 13 is configured using, for example, a liquid crystal display (LCD) or organic electroluminescence (EL). Display unit 13 displays an image of the real world itself or a virtual space in which virtual production facilities are superimposed on the real world. Display unit 13 realizes mixed reality by displaying, for example, an image of a virtual space in which virtual production facilities generated by processor 11 are superimposed on a captured image of a real world captured by camera 15, an image of a taught teaching point, virtual operation menu VBT (see FIG. 15) including a virtual operation button capable of accepting worker's operation, or the like.

Depth sensor 14 is a sensor that measures a distance between MR device DV and a real-world object and recognizes a three-dimensional shape of the real-world object (for example, hand HND or finger FNG of the worker, workpiece Wk, or a jig, or the like). Depth sensor 14 outputs the recognition result to processor 11. Based on the recognition result output from depth sensor 14, processor 11 recognizes the position, shape, or posture of hand HND or finger FNG of the worker in the air, or recognizes the movement of hand HND or finger FNG of the worker in the air, and accepts the operation (hereinafter, denoted as “aerial operation”) of the worker in the air.

Camera 15 captures an image of an area (real world) corresponding to the field of view of the worker wearing MR device DV. Camera 15 outputs the captured image to processor 11.

Processing device P1 includes communication unit 20, processor 21, and memory 22.

Communication unit 20 is connected to MR device DV and the robot controller so as to be able to perform wireless communication or wired communication and transmits and receives data. Communication unit 20 outputs various data transmitted from MR device DV to processor 21. Communication unit 20 transmits various data output from processor 21 to MR device DV or the robot controller. The wireless communication here is communication via a wireless LAN such as Wi-Fi (registered trademark).

Processor 21 is configured using, for example, a CPU or an FPGA, and performs various types of processing and control in cooperation with memory 22. Specifically, processor 21 refers to programs and data stored in memory 22 and executes the programs to implement various functions for generating a welding teaching program.

Memory 22 includes, for example, a RAM as a work memory used when each processing of processor 21 is executed, and a ROM that stores a program and data that defines each operation of processor 21. Data or information generated or acquired by processor 21 is temporarily stored in the RAM. A program that defines the operation of processor 21 is written to the ROM. Memory 22 includes teaching information recorder 221 and workpiece information recorder 222. Teaching information recorder 221 and workpiece information recorder 222 may be recorded in memory 12 of MR device DV. Memory 22 records a 3D model of welding robot RB or information regarding a robot coordinate system of welding robot RB.

Teaching information recorder 221 records information regarding the positions and postures of the plurality of teaching points transmitted from MR device DV for each workpiece Wk.

Workpiece information recorder 222 records the 3D model of workpiece Wk. Note that the 3D model of workpiece Wk may be generated based on the appearance shape of workpiece Wk detected by depth sensor 14 of MR device DV.

### Teaching Method of Teaching Position by Fingertip Teaching Method

A method of teaching the teaching position by the fingertip teaching method will be described. The fingertip teaching method here is a method of teaching the teaching position of the teaching point based on the direction in which the fingertip of finger FNG of the worker points. The fingertip teaching method is executed in a case where the distance between the fingertip of finger FNG of the worker and workpiece Wk1 is short (for example, 2 cm or 5 cm), and it is assumed that the welding quality is not deteriorated due to the accuracy of the teaching position taught by finger FNG of the worker. Note that the above-described distance is a distance in which it is assumed that the welding quality is not deteriorated due to the accuracy of the teaching position taught by finger FNG of the worker, and an arbitrary distance may be set based on workpiece Wk1, the required welding quality, or the like.

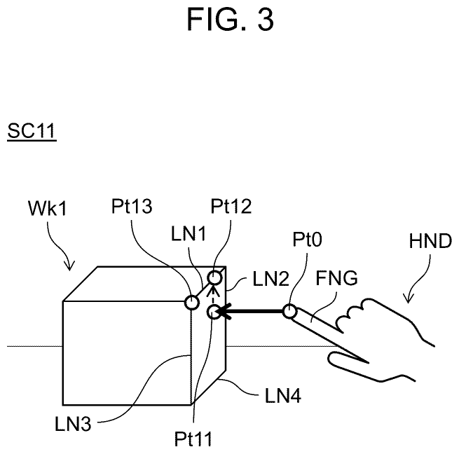

Next, an example of teaching the teaching position by the fingertip teaching method will be described with reference to FIG. 3. FIG. 3 is a diagram for explaining an example of the fingertip teaching method.

In the example illustrated in FIG. 3, the worker points index finger FNG of hand HND toward workpiece Wk1 to teach the teaching point. MR device DV accepts the teaching operation of the teaching point by the worker based on the captured image captured by camera 15 and an object (here, workpiece Wk1 and hand HND and finger FNG of the worker) recognized by depth sensor 14.

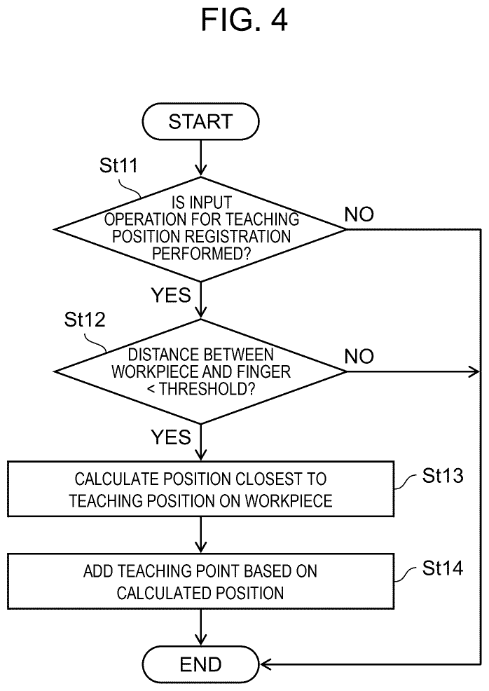

Specifically, when MR device DV starts the processing of accepting the teaching operation of the teaching point by the worker, MR device DV detects fingertip position Pt0 (three-dimensional position) of the recognized finger FNG (index finger) of the worker and the direction (that is, the extending direction of finger FNG) pointed by finger FNG. MR device DV calculates an intersection position where the direction indicated by finger FNG intersects the mesh data (here, workpiece Wk1), and registers (records) the intersection position as teaching position Pt11 of the teaching point. A method of calculating teaching position Pt11 will be described in detail with reference to FIG. 4.

In addition, MR device DV generates teaching image SC11 in which an image of a point (○ indicating teaching position Pt11) indicating the position pointed by fingertip position Pt0 of the worker is superimposed on the intersection position on the mesh data, and displays teaching image SC11 on display unit 13. As a result, MR device DV visualizes the teaching position taught based on the worker's operation to the worker, thereby supporting the teaching work of the teaching position.

Next, a teaching processing example of the teaching position by the fingertip teaching method will be described with reference to FIG. 4. FIG. 4 is a flowchart illustrating an example of a teaching procedure of a teaching position by the fingertip teaching method of MR device DV in the exemplary embodiment.

MR device DV determines whether there is an input operation of registering the teaching position of the teaching point based on the captured image captured by camera 15 and the recognition result of hand HND of the worker recognized by depth sensor 14 (St11).

In a case where it is determined in step St11 that there is an input operation of registering the teaching position of the teaching point (St11, YES), MR device DV measures the distance between workpiece Wk1 and finger FNG (fingertip position Pt0) of the worker based on the recognition result recognized by depth sensor 14. MR device DV determines whether the distance between workpiece Wk1 and finger FNG of the worker (fingertip position Pt0 illustrated in FIG. 3) is less than a threshold (for example, 2 cm or 5 cm) (St12). The threshold is a distance at which it is assumed that the welding quality is not deteriorated due to the accuracy of the teaching position taught by finger FNG of the worker, and an arbitrary distance may be set based on workpiece Wk1 or the required welding quality.

On the other hand, in a case where it is determined in step St11 that there is no input operation to register the teaching position of the teaching point (St11, NO), MR device DV ends the teaching processing of the teaching position illustrated in FIG. 4.

In a case where it is determined that the distance between workpiece Wk1 and finger FNG of the worker is less than the threshold in step St12 (St12, YES), MR device DV calculates an intersection position where the direction (that is, the extending direction of finger FNG) in which finger FNG points and the mesh data (here, workpiece Wk1) intersect on workpiece Wk1 (St13).

MR device DV corrects the teaching position to the intersection position closest to the fingertip of finger FNG among the calculated intersection positions, and additionally registers the corrected teaching position as the teaching position of the teaching point corresponding to workpiece Wk1 (St14).

The correction of the teaching position is not limited to the above-described correction processing, and other correction processing may be executed.

For example, in a case where a side (in the example illustrated in FIG. 3, sides LN1, LN2, LN3, LN4) corresponding to the outline of workpiece Wk1 exists around the corrected teaching position (in the example illustrated in FIG. 3, teaching position Pt11) in step St13, MR device DV selects a side (in the example illustrated in FIG. 3, side LN1) closest to the teaching position among these sides. MR device DV may correct the position on this side where the Euclidean distance between the side and the teaching position is the shortest (in the example illustrated in FIG. 3, teaching position Pt12) to the teaching position, and additionally register this position as the teaching position of the teaching point of workpiece Wk1 (St14).

In addition, in step St13, MR device DV may output two positions of the calculated intersection position (that is, teaching position Pt11 illustrated in FIG. 3) and the position where the Euclidean distance between the side and the teaching position is the shortest (that is, teaching position Pt12 illustrated in FIG. 3) as candidates for the corrected teaching position of the teaching point. Furthermore, in a case where the vertex exists around the position (point) where the Euclidean distance between the side and the teaching position is the shortest in step St13, MR device DV may output three positions of the calculated intersection position (that is, teaching position Pt11 illustrated in FIG. 3), the position (that is, teaching position Pt 12 illustrated in FIG. 3) on the side where the Euclidean distance between the side and the teaching position is the shortest, and the position (that is, teaching position Pt12 illustrated in FIG. 3) of the vertex existing around the position where the Euclidean distance between the side and the teaching position is the shortest as candidates for the teaching position of the corrected teaching point. Note that MR device DV generates each of candidates for the teaching position of the teaching point as a virtual operation button or a virtual teaching point that can be selected (operated) by the aerial operation of the worker and displays the generated candidates on display unit 13. In a case where MR device DV outputs the plurality of corrected positions as candidates for the teaching position of the teaching point, MR device DV accepts a selection operation of a virtual operation button or a virtual teaching point displayed on display unit 13 by the aerial operation of the worker recognized by depth sensor 14. MR device DV may additionally register the virtual operation button selected by the aerial operation or the teaching position based on the virtual teaching point as the teaching position of the teaching point (St14).

As described above, MR device DV in the exemplary embodiment can more effectively suppress the decrease in the positional accuracy of the teaching position by accepting the teaching of the teaching position of the teaching point by finger FNG of the worker only in a case where it is determined that the distance between fingertip position Pt0 and the mesh data intersecting the direction in which finger FNG points is less than the threshold.

In addition, MR device DV in the exemplary embodiment corrects the position of the mesh data intersecting the direction in which finger FNG points, and outputs a candidate of the teaching position. As a result, MR device DV can support the teaching work of the teaching position by the worker and acquire a more accurate teaching position by outputting the teaching position candidate even in a case where the worker teaches a position such as a point or a vertex on the side of workpiece Wk1 that is difficult to point using finger FNG. The worker can teach the teaching position more easily by selecting the teaching position desired by the worker from the candidates of the teaching position (for example, teaching positions Pt11 to Pt13) displayed on display unit 13. As described above, MR device DV can more effectively suppress the decrease in the position accuracy of the teaching position even in a case where the teaching of the teaching position is accepted by hand HND (finger FNG) of the worker.

### Teaching Method of Teaching Position by Remote Point Teaching Method

A method of teaching the teaching position by the remote point teaching method will be described. The remote point teaching method here is a method of teaching the teaching position of the teaching point at a position far away from finger FNG based on the direction in which the fingertip of finger FNG of the worker points. The remote point teaching method is performed in a case where there is another mesh closer to the fingertip than the mesh intended by the worker, in which the distance between the fingertip of finger FNG of the worker and the teaching point on workpiece Wk1 intended by the worker is long (for example, 10 cm or 30 cm or more). Note that the above-described distance is a distance assumed to be applicable to a workpiece having a simple shape, and an arbitrary distance may be set based on the shape of the workpiece, the movable range of the worker, or the like.

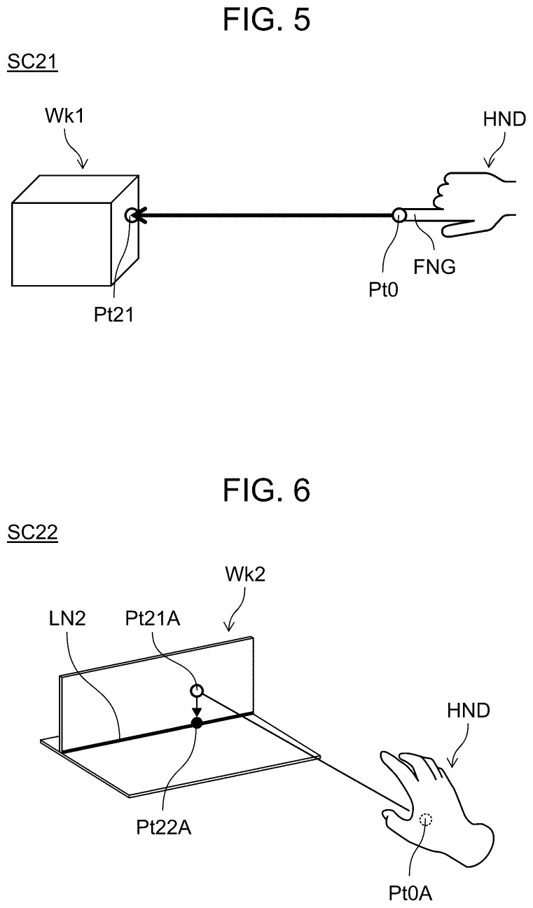

Next, an example of teaching the teaching position by the remote point teaching method will be described with reference to FIG. 5. FIG. 5 is a diagram for explaining an example of the remote point teaching method.

In the example illustrated in FIG. 5, the worker points index finger FNG of hand HND toward workpiece Wk1 to teach teaching position Pt21. MR device DV accepts the teaching operation of the teaching point by the worker based on the captured image captured by camera 15 and an object (here, workpiece Wk1 and hand HND and finger FNG of the worker) recognized by depth sensor 14.

Specifically, when MR device DV starts the processing of accepting the teaching operation of the teaching point by the worker, MR device DV detects fingertip position Pt0 (three-dimensional position) of the recognized finger FNG (index finger) of the worker and the direction (that is, the extending direction of finger FNG) pointed by finger FNG. MR device DV calculates an intersection position where the direction indicated by finger FNG intersects the mesh data (here, workpiece Wk1), and registers (records) the intersection position as teaching position Pt21 of the teaching point.

In addition, MR device DV generates teaching image SC21 in which an image of a point (“○” indicating teaching position Pt21) indicating the position pointed by fingertip position Pt0 of the worker is superimposed on the intersection position on the mesh data, and displays teaching image SC21 on display unit 13. As a result, MR device DV visualizes the teaching position taught based on the worker's operation to the worker, thereby supporting the teaching work of the teaching position.

Next, another method of teaching the teaching position by hand HND of the worker will be described with reference to FIG. 6. FIG. 6 is a diagram for explaining another teaching method and another correction method of the teaching position.

In the example illustrated in FIG. 6, the worker teaches teaching position Pt21A by the direction in which the palm of hand HND faces workpiece Wk2 and center position Pt0A of the palm. MR device DV accepts the teaching operation of the teaching point by the worker based on the captured image captured by camera 15 and the object (here, workpiece Wk2 and the palm of the worker) recognized by depth sensor 14.

Specifically, when MR device DV starts the processing of accepting the teaching operation of the teaching point by the worker, MR device DV detects recognized center position Pt0A (three-dimensional position) of the palm of the worker and the direction (that is, the direction from the back of the hand toward the palm) in which the palm is facing. MR device DV calculates an intersection position where a straight line extended from center position Pt0A of the palm in a direction in which the palm is directed intersects mesh data (here, workpiece Wk2). MR device DV corrects the teaching position to the intersection position (that is, teaching position Pt21A) closest to center position Pt0A of the palm among the calculated intersection positions, and additionally registers the corrected teaching position as teaching position Pt21A of workpiece Wk2.

Note that MR device DV may register (record) teaching position Pt21A obtained by correcting teaching position Pt22A. For example, MR device DV may output two positions, that is, teaching position Pt21A where the intersection position is corrected and the position (that is, teaching position Pt22A illustrated in FIG. 6) where the Euclidean distance between the boundary LN21 where the base material and the base material constituting workpiece Wk2 overlap with each other becomes the shortest, as candidates for the teaching position of the corrected teaching point.

In addition, MR device DV generates teaching image SC22 in which an image of a point (“○” indicating teaching position Pt21A) indicating the calculated intersection position or an image of a point (“○” indicating teaching position Pt21A and teaching position Pt22A) indicating the candidate position of the teaching position is superimposed on the intersection position on the mesh data, and displays teaching image SC22 on display unit 13. As a result, MR device DV visualizes the teaching position taught based on the worker's operation to the worker, thereby supporting the teaching work of the teaching position. In a case where MR device DV displays the points indicating the candidates for the teaching position, MR device DV accepts a worker's operation of selecting any one of the points indicating the candidates for the teaching position as the teaching position.

In the above description, the teaching processing of the teaching position in the present exemplary embodiment has been described. In the following description, the teaching processing of the teaching posture in the present exemplary embodiment will be described.

### Teaching Method of Teaching Posture

MR device DV detects the direction (posture) of the fingers of the worker based on the captured image captured by camera 15 and the recognition result recognized by depth sensor 14. MR device DV accepts a teaching operation of teaching the posture of welding torch TC at the teaching position based on the detected direction (posture) of the fingers of the worker.

### First Teaching Method of Teaching Posture

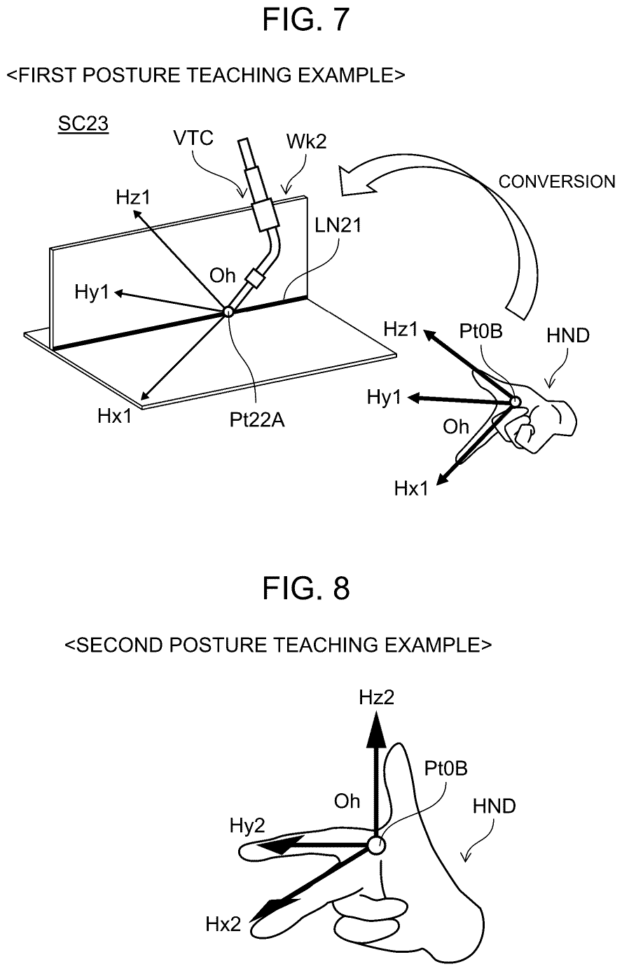

First, a first teaching example of a teaching posture in the present exemplary embodiment will be described with reference to FIG. 7. FIG. 7 is a diagram for explaining the first teaching example of the teaching posture.

In the first teaching example of the teaching posture, MR device DV accepts the teaching of the teaching posture based on the directions of the two fingers (thumb and index finger) of the worker. The worker forms a posture in which the thumb and the index finger draw an L shape, and teaches hand HND in this posture resembling the posture of welding torch TC on the teaching point.

MR device DV detects the direction in which each of the thumb and the index finger of the worker points based on the captured image captured by camera 15 and the recognition result recognized by depth sensor 14. MR device DV acquires the detected direction of the index finger as first direction Hx1, and acquires a direction perpendicular to first direction Hx1 among the directions of the thumb as second direction Hz1. MR device DV acquires a direction perpendicular to first direction Hx1 and second direction Hz1 acquired as third direction Hy1. MR device DV calculates teaching coordinate system Oh in which intersection Pt0B of each of the detected first direction Hx1, second direction Hz1, and third direction Hy1 is an origin position, and first direction Hx1, second direction Hz1, and third direction Hy1 acquired are a three-dimensional coordinate system. That is, teaching coordinate system Oh corresponds to the coordinate system of welding torch TC.

MR device DV acquires the teaching posture of welding torch TC at teaching position Pt22A based on teaching coordinate system Oh with respect to the real-world coordinate system (that is, the world coordinate system) appearing in the captured image captured by camera 15. Here, welding torch TC is provided at the tip of welding robot RB which is an articulated robot. Therefore, MR device DV calculates, on the robot coordinate system of welding robot RB, a conversion parameter for converting the posture into the posture of welding robot RB for performing the welding operation with the acquired teaching posture of welding torch TC, and registers the calculated conversion parameter as the teaching posture at the teaching point.

In addition, as illustrated in FIG. 7, MR device DV may generate virtual welding torch VTC corresponding to the taught teaching posture based on the teaching posture taught by hand HND of the worker. MR device DV may generate teaching image SC23 in which the tip position of generated virtual welding torch VTC is aligned and superimposed on teaching position Pt22A of workpiece Wk2 appearing in the captured image captured by camera 15, and display teaching image SC23 on display unit 13. As a result, MR device DV can visualize the teaching posture during teaching to the worker.

### Second Teaching Method of Teaching Posture

First, a second teaching example of a teaching posture in the present exemplary embodiment will be described with reference to FIG. 8. FIG. 8 is a diagram for explaining the second teaching example of the teaching posture.

In the second teaching example of the teaching posture, MR device DV accepts the teaching of the teaching posture based on the directions of three fingers (thumb, index finger and middle finger) of the worker. The worker forms a posture used in the so-called Fleming's law in which the directions of the thumb, the index finger, and the middle finger are erected in directions orthogonal to each other, and teaches hand HND in this posture resembling the posture of welding torch TC on the teaching point.

MR device DV detects the direction in which each of the thumb, the index finger, and the middle finger of the worker points based on the captured image captured by camera 15 and the recognition result recognized by depth sensor 14. MR device DV acquires the detected direction of the index finger as first direction Hx2, the detected direction of the thumb as second direction H22, and the detected direction of the middle finger as third direction Hy2. MR device DV calculates teaching coordinate system Oh in which intersection Pt0B of each of the detected first direction Hx2, second direction Hz2, and third direction Hy2 is an origin position, and first direction Hx2, second direction Hz2, and third direction Hy2 acquired are a three-dimensional coordinate system.

### Third Teaching Method of Teaching Posture

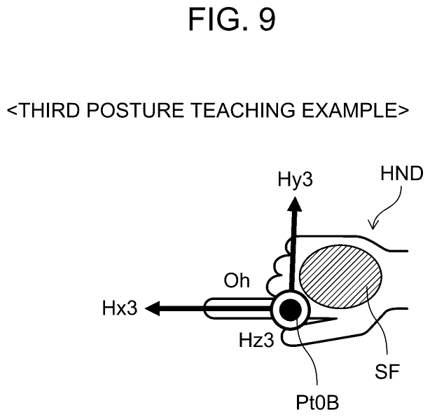

First, a third teaching example of a teaching posture in the present exemplary embodiment will be described with reference to FIG. 9. FIG. 9 is a diagram for explaining the third teaching example of the teaching posture.

In the third teaching example of the teaching posture, MR device DV accepts the teaching of the teaching posture based on the direction of one finger (in the example illustrated in FIG. 9, the index finger) of the worker and surface SF of the back of the hand or the surface of the palm of hand HND. The worker makes a posture in which one finger is raised used for posture teaching, and teaches hand HND in this posture resembling the posture of welding torch TC on the teaching point. Note that, in the example illustrated in FIG. 9, an example of accepting teaching of the teaching posture based on the back of hand HND will be described.

MR device DV detects the direction indicated by the index finger of the worker and surface SF of the back of hand HND based on the captured image captured by camera 15 and the recognition result recognized by depth sensor 14. MR device DV acquires the detected direction of the index finger as first direction Hx3. In addition, MR device DV calculates a normal direction with respect to surface SF detected of the back of the hand, and acquires a direction that is the normal direction and is perpendicular to first direction Hx3 as second direction Hz3. MR device DV acquires a direction perpendicular to first direction Hx3 and second direction Hz3 acquired as third direction Hy3. MR device DV calculates teaching coordinate system Oh in which intersection Pt0B of each of the detected first direction Hx3, second direction Hz3, and third direction Hy3 is an origin position, and first direction Hx3, second direction Hz3, and third direction Hy3 acquired are a three-dimensional coordinate system.

### Operation Procedure of Welding Teaching System

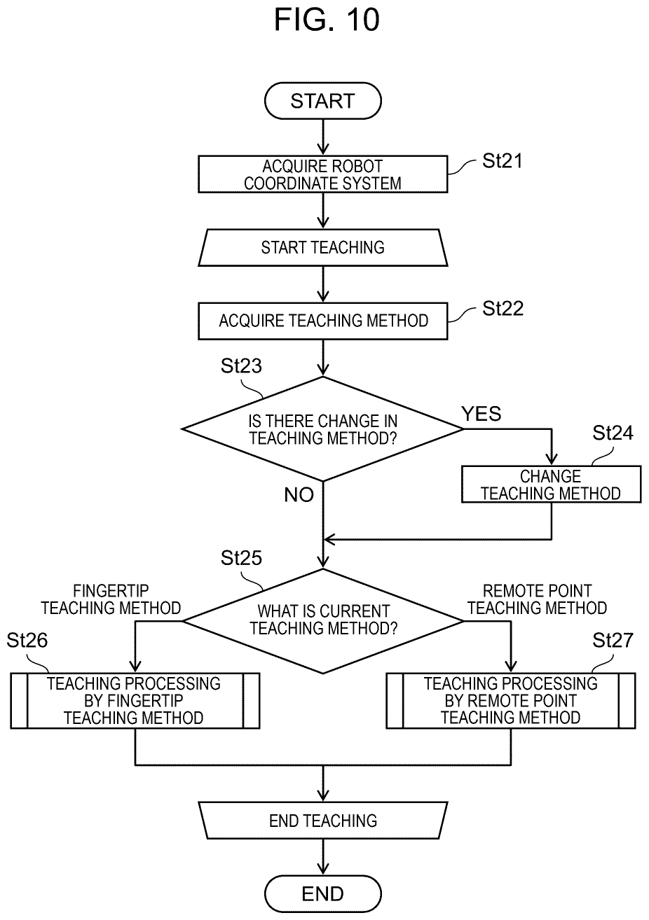

Next, an operation procedure of MR device DV in the exemplary embodiment will be described with reference to FIG. 10. FIG. 10 is a flowchart illustrating a motion procedure example of MR device DV in the exemplary embodiment.

MR device DV requests processing device P1 for information of the robot coordinate system of welding robot RB to be taught, and acquires information of the robot coordinate system (St21).

MR device DV starts the processing of accepting the teaching operation of the teaching point by hand HND of the worker. MR device DV acquires information indicating whether the teaching of the teaching point is performed by either the fingertip teaching method or the remote point teaching method (St22). Here, MR device DV may acquire the information of the teaching method based on the selection operation by the worker's operation, or may acquire the information by referring to the information of the teaching method set in advance.

MR device DV determines whether there is a change in the teaching method of the teaching position and the teaching posture of the teaching point based on the acquired information of the teaching method and the information of the currently set teaching method (St23).

In a case where it is determined in step St23 that there is a change in the teaching method of the teaching position and the teaching posture of the teaching point (St23, YES), MR device DV changes the current teaching method to another teaching method (St24). On the other hand, in a case where MR device DV determines in step St23 that there is no change in the teaching method of the teaching position and the teaching posture of the teaching point (St23, NO), the change of the current teaching method is omitted.

MR device DV determines whether the current teaching method is the fingertip teaching method or the remote point teaching method (St25).

In a case where it is determined in step St25 that the current teaching method is the fingertip teaching method (St25, fingertip teaching method), MR device DV executes the teaching processing of the teaching position and the teaching posture of the teaching point by the fingertip teaching method (St26).

On the other hand, in a case where it is determined in step St25 that the current teaching method is the remote point teaching method (St25, remote point teaching method), MR device DV executes the teaching processing of the teaching position and the teaching posture of the teaching point by the remote point teaching method (St27).

After the teaching of the teaching point by the fingertip teaching method or the remote point teaching method is completed, MR device DV ends the operation procedure illustrated in FIG. 10. Note that the operation procedure illustrated in FIG. 10 is an operation procedure for teaching one teaching point as an example, but teaching of a plurality of teaching points may be performed by repeatedly executing the process of step St26 or step St27 a number of times corresponding to the number of teaching points.

### Teaching Procedure of Teaching Point by Fingertip Teaching Method

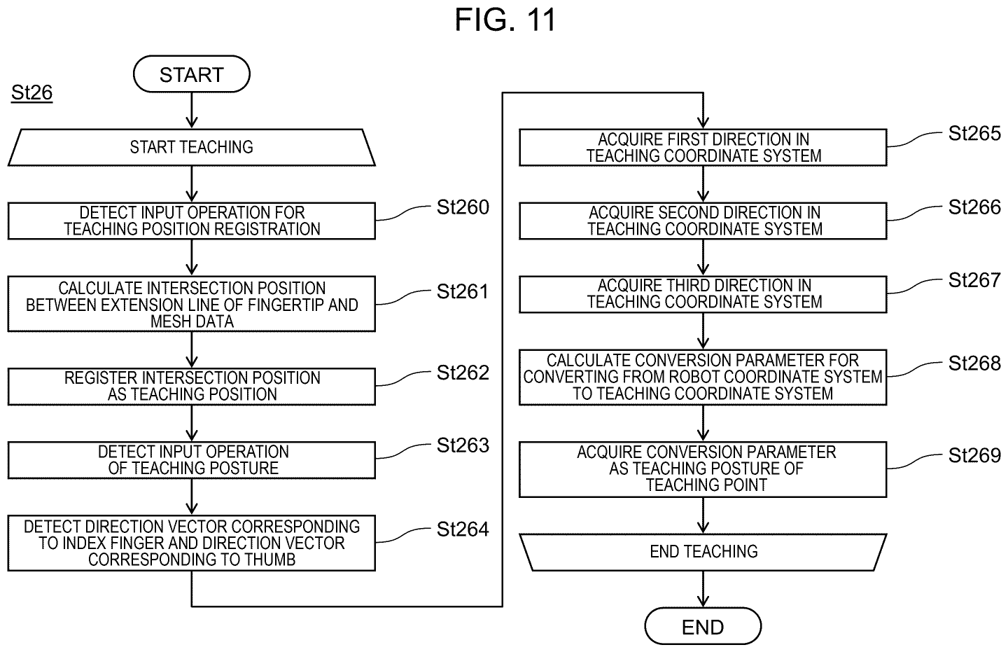

Next, a teaching procedure (step St26) of the teaching point by the fingertip teaching method illustrated in FIG. 10 will be described with reference to FIG. 11. FIG. 11 is a flowchart illustrating an example of a teaching procedure by the fingertip teaching method of MR device DV in the exemplary embodiment. In the description of FIG. 11, as an example, an example in which the input operation of the teaching posture is accepted by the method illustrated in the first teaching example of the teaching posture will be described.

When the teaching processing by the fingertip teaching method is started, MR device DV detects an input operation by the worker for registering the teaching position based on the captured image captured by camera 15 and the recognition result recognized by depth sensor 14 (St260). Note that the input operation by the worker for registering the teaching position may be any input operation, and is, for example, a selection (pressing) operation of a real-world physical button or a virtual operation button displayed on display unit 13, a voice input by the worker's voice, an input operation based on the movement of the worker's eyes or eyelids, another input operation specified in advance, or the like. MR device DV recognizes finger FNG of the worker based on the captured image captured by camera 15 and the recognition result recognized by depth sensor 14, and calculates the intersection position of the extension line from fingertip position Pt0 of finger FNG toward finger FNG and the mesh data based on the recognition result recognized by depth sensor 14 (St261).

MR device DV registers the intersection position as the teaching position (St262). Note that MR device DV may register a correction position (for example, teaching position Pt 12 illustrated in FIG. 3) obtained by correcting the intersection position (for example, teaching position Pt11 illustrated in FIG. 3) as the teaching position, or may output (display) each of the intersection position and the plurality of corrected positions (for example, teaching positions Pt11 to Pt13 illustrated in FIG. 3) as a candidate for the teaching position and register any position selected by the worker's operation as the teaching position.

MR device DV detects the input operation of the teaching posture by the worker based on the captured image captured by camera 15 and the recognition result recognized by depth sensor 14 (St263).

MR device DV detects direction vectors respectively pointed by the thumb and the index finger of the worker based on the captured image captured by camera 15 and the recognition result recognized by depth sensor 14 (St264).

MR device DV acquires the detected direction of the index finger as first direction Hx1 (St265), and acquires a direction perpendicular to first direction Hx1 among the directions of the thumb as second direction Hz1 (St266). MR device DV acquires a direction perpendicular to first direction Hx1 and second direction Hz1 acquired as third direction Hy1 (St267).

MR device DV calculates teaching coordinate system Oh in which intersection Pt0B of each of the detected first direction Hx1, second direction Hz1, and third direction Hy1 is an origin position, and first direction Hx1, second direction Hz1, and third direction Hy1 acquired are a three-dimensional coordinate system. Based on the calculated teaching coordinate system Oh and the robot coordinate system of welding robot RB, MR device DV calculates a conversion parameter for conversion into a posture of welding robot RB for performing the welding operation with the acquired teaching posture of welding torch TC on the robot coordinate system of welding robot RB (St268).

MR device DV records the calculated conversion parameter as a teaching posture at the teaching point in association with the teaching position of the teaching point (St269). After acquiring the teaching position and the teaching posture of the teaching point, MR device DV ends the teaching processing by the fingertip teaching method.

Note that MR device DV may determine whether the distance between fingertip position Pt0 and the intersection position of workpiece Wk1 (mesh data) is less than the threshold in the process of step St261. In a case where it is determined that the distance between fingertip position Pt0 and the intersection position of workpiece Wk1 (mesh data) is less than the threshold, MR device DV may generate and output a notification indicating that the distance between fingertip position Pt0 and the intersection position of workpiece Wk1 (mesh data) is less than the threshold, or may generate and output a notification recommending switching to the remote point teaching method.

As described above, MR device DV in the exemplary embodiment can accept registration of the teaching position and the teaching posture of the teaching point using hand HND and finger FNG of the worker.

### Teaching Procedure of Teaching Point by Remote Point Teaching Method

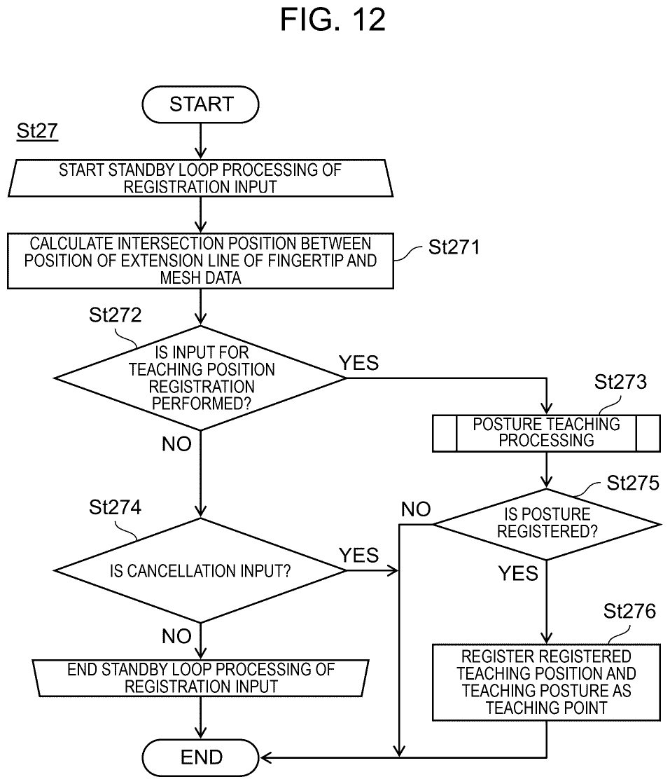

Next, a teaching procedure (step St27) of the teaching point by the remote point teaching method illustrated in FIG. 10 will be described with reference to FIG. 12. FIG. 12 is a flowchart illustrating an example of a teaching procedure by the remote point teaching method of MR device DV in the exemplary embodiment.

When MR device DV starts the teaching processing by the remote point teaching method, MR device DV recognizes finger FNG of the worker based on the captured image captured by camera 15 and the recognition result recognized by depth sensor 14, and calculates the intersection position of the extension line from fingertip position Pt0 of finger FNG toward finger FNG and the mesh data based on the recognition result recognized by depth sensor 14 (St271).

MR device DV detects the presence or absence of an input operation by the worker for registering the teaching position based on the captured image captured by camera 15 and the recognition result recognized by depth sensor 14. Note that the input operation by the worker for registering the teaching position may be any input operation, and is, for example, a selection (pressing) operation of a real-world physical button or a virtual operation button displayed on display unit 13, a voice input by the worker's voice, an input operation based on the movement of the worker's eyes or eyelids, another input operation specified in advance, or the like. MR device DV determines whether there is an input operation of teaching position registration by the worker (St272).

In a case where it is determined in step St272 that there is the input operation of the teaching position registration by the worker (St272, YES), MR device DV executes posture teaching processing of accepting the teaching posture at the teaching point (St273).

On the other hand, in a case where it is determined in step St272 that there is no input operation of teaching position registration by the worker (St272, NO), MR device DV determines whether there is a cancel operation (input) of canceling the registration of the teaching position of the teaching point by the worker (St274).

In a case where it is determined in step St274 that there is the cancel operation (input) (St274, YES), MR device DV ends the teaching processing (that is, the process of step St27) of the teaching point by the remote point teaching method.

On the other hand, in a case where it is determined in step St274 that there is no cancel operation (input) (St274, NO), MR device DV ends the standby loop processing of waiting for registration of teaching of the posture of the teaching point by the remote point teaching method.

MR device DV determines whether there is a registration operation of the teaching posture of the teaching point acquired by the posture teaching processing based on the worker's operation (St275).

In a case where it is determined in step St275 that there is the registration operation of the teaching position of the teaching point (St275, YES), MR device DV registers the registered teaching position and teaching posture as the teaching point (St276).

On the other hand, in a case where it is determined in step St275 that there is no registration operation of the teaching posture of the teaching point (St275, NO), MR device DV ends the teaching processing of the teaching point by the remote point teaching method (that is, the process of step St27).

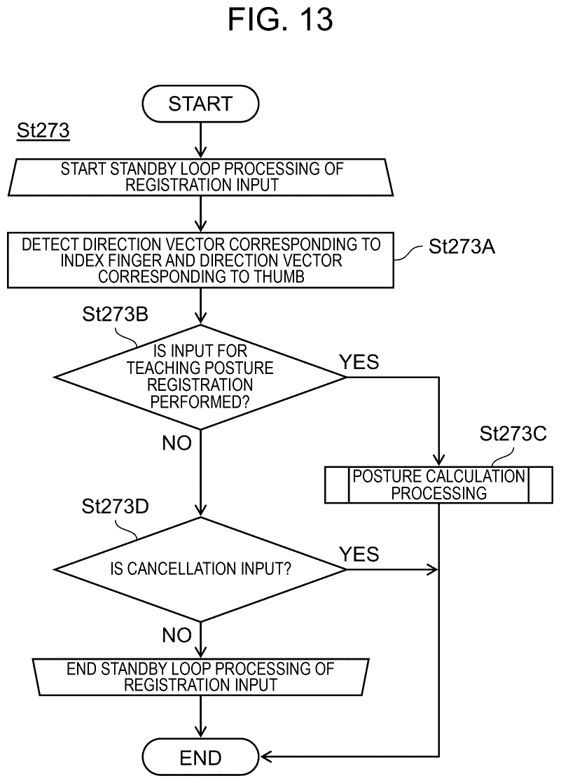

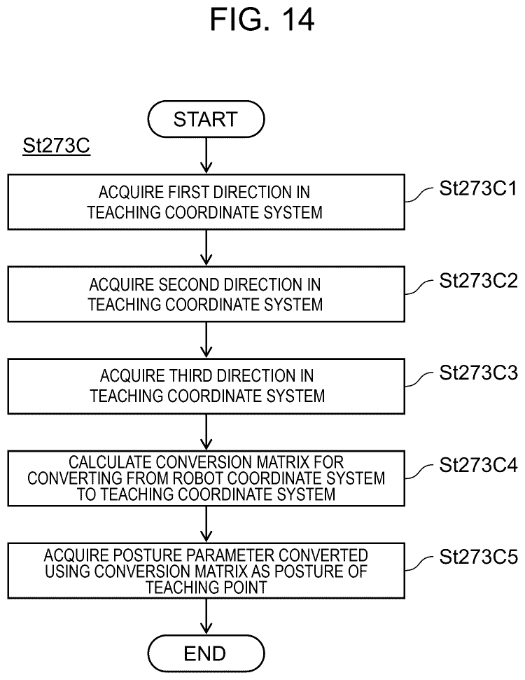

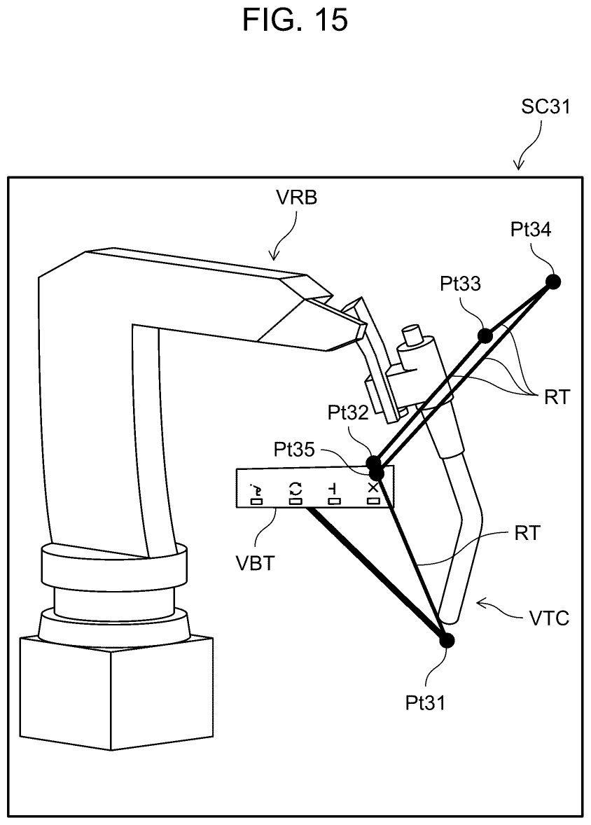

Next, the posture teaching procedure (step St273) and the posture calculation procedure (step St273C) of the teaching point by the remote point teaching method illustrated in FIG. 10 will be described with reference to FIGS. 13 and 14. FIG. 13 is a flowchart illustrating an example of a posture teaching processing procedure of MR device DV in the exemplary embodiment. FIG. 14 is a flowchart illustrating an example of a posture calculation processing procedure of MR device DV in the exemplary embodiment. In the description of FIGS. 13 and 14, as an example, an example in which the input operation of the teaching posture is accepted by the method illustrated in the first teaching example of the teaching posture will be described.

MR device DV detects direction vectors respectively pointed by the thumb and the index finger of the worker based on the captured image captured by camera 15 and the recognition result recognized by depth sensor 14 (St273A).

MR device DV determines whether there is an input operation of registering the teaching posture by the worker (St273B).

In a case where it is determined in step St273B that there is the input operation of registering the teaching posture (St273B, YES), MR device DV executes the posture calculation processing based on the detected direction vectors respectively pointed by the thumb and the index finger of the worker (St273C).

On the other hand, in a case where it is determined in step St273B that there is no input operation to register the teaching posture (St273B, NO), MR device DV determines whether there is a cancel operation (input) to cancel the registration of the teaching position of the teaching point by the worker (St273D).

In a case where it is determined in step St273D that there is the cancel operation (input) (St273D, YES), MR device DV ends the teaching processing (that is, the process of step St273D) of the teaching point by the remote point teaching method.

On the other hand, in a case where it is determined in step St273D that there is no cancel operation (input) (St273D, NO), MR device DV ends the standby loop processing of waiting for registration of teaching of the posture of the teaching point by the remote point teaching method.

When starting the posture calculation processing in step St273C, MR device DV acquires the detected direction of the index finger as first direction Hx1 (St273C1), and acquires a direction perpendicular to first direction Hx1 among the directions of the thumb as second direction Hz1 (St273C2). MR device DV acquires a direction perpendicular to first direction Hx1 and second direction Hz1 acquired as third direction Hy1 (St273C3).

MR device DV calculates teaching coordinate system Oh in which intersection Pt0B of each of the detected first direction Hx1, second direction Hz1, and third direction Hy1 is an origin position, and first direction Hx1, second direction Hz1, and third direction Hy1 acquired are a three-dimensional coordinate system. Based on the calculated teaching coordinate system Oh and the robot coordinate system of welding robot RB, MR device DV calculates a conversion parameter for conversion into a posture of welding robot RB for performing the welding operation with the acquired teaching posture of welding torch TC on the robot coordinate system of welding robot RB (St273C4).

MR device DV records the calculated conversion parameter as a teaching posture at the teaching point in association with the teaching position of the teaching point (St273C5). After acquiring the teaching position and the teaching posture of the teaching point, MR device DV ends the teaching processing by the remote point teaching method.

As described above, MR device DV in the exemplary embodiment can accept registration of the teaching position and the teaching posture of the teaching point by hand HND and finger FNG of the worker even in a case where the teaching position on workpiece Wk or workpiece Wk is far away from hand HND and finger FNG of the worker and it is difficult for the teaching point to directly point.

Next, an example of a mixed reality space in which a teaching result is displayed will be described with reference to FIG. 15. FIG. 15 is a diagram illustrating an example of a mixed reality space visually recognized by a worker.

Based on each of the taught teaching points, MR device DV generates images of virtual teaching points Pt31, Pt32, Pt33, Pt34, Pt35 for visualizing the teaching position, virtual welding motion trajectory RT in which welding robot RB that welds a workpiece (not illustrated) performs a welding operation, virtual welding robot VRB including virtual welding torch VTC, and operation menu VBT capable of accepting an operation on the taught teaching point (that is, virtual teaching points Pt31 to Pt35).

Operation menu VBT includes at least one operation button capable of accepting each operation such as editing or deleting the teaching point. MR device DV accepts an operation of selecting an operation button based on an aerial operation by the worker. In addition, simulation image SC31 may include an operation button or the like that simulates the operation of each of virtual welding robot VRB and virtual welding torch VTC that execute the welding operation based on each teaching point and the welding motion trajectory, and can accept an operation or the like that reproduces the operation of each of virtual welding robot VRB and virtual welding torch VTC that are simulation results.

MR device DV generates and displays simulation image SC31 (see FIG. 15), which is a mixed reality space in which each of virtual teaching points Pt31 to Pt35, virtual welding motion trajectory RT, and virtual welding robot VRB are superimposed on the captured image of a real world captured by camera 15. Note that simulation image SC31 may include a real-world or virtual work, or another real-world or virtual production facility, or the like.

As described above, MR device DV in the exemplary embodiment can support the confirmation work of whether the teaching result of the teaching point by hand HND and finger FNG of the worker is the teaching content desired by the worker and the correction work of the teaching point. As a result, the worker can correct the teaching point based on the position of each of virtual teaching points Pt31 to Pt35 displayed in simulation image SC31, virtual welding motion trajectory RT, and the welding operation of virtual welding robot VRB and virtual welding torch VTC.

### Appendix

The following technique is disclosed by the above description of each exemplary embodiment.

### Technology 1-1

A robot teaching system (MR device DV) including:

a teaching data storage unit (memory 12) that stores teaching data (that is, data of teaching information) of a robot (welding robot RB) existing in an actual environment (that is, real world);

a teaching point storage unit (memory 12) that stores teaching point data (image data indicating the teaching position, for example, data of “○” indicating teaching position Pt11 illustrated in FIG. 3) corresponding to a teaching point used to display the teaching data;

a display device (display unit 13) that is configured to be mountable to a worker and displays an image to be superimposed on an image of the actual environment or the actual environment itself; and

a positional relationship acquisition unit (processor 11) that acquires a relative positional relationship between the actual environment and the display device (display unit 13);

an image generation unit (processor 11) that generates a display image (for example, teaching image SC11 illustrated in FIG. 3 and the like) for displaying the teaching point so as to have a predetermined positional relationship with respect to the display device (display unit 13) based on the relative positional relationship and the teaching point data;

an output unit (processor 11) that outputs the display image to the display device (display unit 13);

a detection unit (depth sensor 14 or camera 15) that detects an aerial operation that is an operation performed by the worker in the air separated from the display device (display unit 13) on workpiece Wk existing in the actual environment; and

a feature point extraction unit (depth sensor 14 or camera 15) that recognizes a feature point of workpiece Wk (a side or a vertex of workpiece Wk), in which

the image generation unit (processor 11) generates the display image for displaying the teaching point in a case where a designated position (for example, teaching position Pt11 illustrated in FIG. 3) designated by the aerial operation is designated in the vicinity of the feature point.

With this configuration, MR device DV can support visual confirmation of the teaching position (designated position) by the worker by visualizing the teaching position taught based on the worker's operation to the worker. As a result, MR device DV improves the teaching accuracy of the teaching position even in a case where the teaching position of the teaching point using hand HND and finger FNG of the worker is taught.

### Technology 1-2

The robot teaching system (MR device DV) according to (Technology 1-1), in which

in a case where the designated position is designated in the vicinity of the feature point by the aerial operation, the image generation unit (processor 11) generates a candidate display image in which a candidate for the teaching point is displayed at each of the designated position and the position of the feature point,

the output unit (processor 11) displays the candidate display image on the display device (display unit 13),

the detection unit (depth sensor 14 or camera 15) detects the aerial operation performed by the worker on the candidate display image, and

the image generation unit (processor 11) accepts an operation of selecting any one of the designated position and the position of the feature point displayed in the candidate display image by the aerial operation, and generates the display image for displaying the teaching point at the selected designated position or position of the feature point.

With this configuration, MR device DV outputs a position obtained by correcting the teaching position taught based on the worker's operation as a candidate, and causes the worker to select and operate which position is a correct teaching position, so that the teaching position can be easily corrected even in a case where the teaching position (designated position) pointed by hand HND and finger FNG of the worker points to a position deviated from the teaching position desired by the worker. As a result, MR device DV can improve the position accuracy of the teaching position even in a case where the teaching position of the teaching point using hand HND and finger FNG of the worker is taught.

### Technology 1-3

The robot teaching system (MR device DV) according to (Technology 1-1) or (Technology 1-2), in which

the detection unit (depth sensor 14 or camera 15) detects a posture of a finger (for example, a thumb, an index finger, a middle finger, a palm, a back of a hand, or the like) of the worker in the air with respect to workpiece Wk,

the image generation unit (processor 11) generates a posture image (teaching image SC23) for displaying a posture (that is, the posture of virtual welding torch VTC indicating the posture of welding robot RB and the posture of welding torch TC included in welding robot RB) of the robot at the designated position designated by a posture of the finger, and

the output unit (processor 11) outputs the posture image to the display device (display unit 13).

With this configuration, even in a case where the position pointed by finger FNG becomes unclear, MR device DV can visualize the teaching position pointed by finger FNG of the worker by displaying teaching image SC21 on which the image “○” indicating teaching position Pt21 is superimposed. As a result, MR device DV can improve the position accuracy of the teaching position even in a case where the teaching position of the teaching point using hand HND and finger FNG of the worker is taught.

### Technology 1-4

A robot teaching system (MR device DV) including:

a model storage unit (memory 12) that stores a three-dimensional model (3D model) of workpiece Wk existing in an actual environment (that is, the real world);

a teaching data storage unit (memory 12) that stores teaching data (that is, data of teaching information) of a robot (welding robot RB) existing in the actual environment (that is, real world);

a teaching point storage unit (memory 12) that stores teaching point data (image data indicating the teaching position, for example, data of “○” indicating teaching position Pt11 illustrated in FIG. 3) corresponding to a teaching point used to display the teaching data;

a display device (display unit 13) that is configured to be mountable to a worker and displays an image to be superimposed on an image of the actual environment or the actual environment itself; and

a positional relationship acquisition unit (processor 11) that acquires a relative positional relationship between the actual environment and the display device (display unit 13);

an image generation unit (processor 11) that generates a display image (for example, teaching image SC11 illustrated in FIG. 3 and the like) for displaying the three-dimensional model and the teaching point so as to have a predetermined positional relationship with respect to the display device (display unit 13) based on the relative positional relationship, the three-dimensional model, and the teaching point data;

an output unit (processor 11) that outputs the display image to the display device (display unit 13);

a detection unit (depth sensor 14 or camera 15) that detects an aerial operation that is an operation performed by the worker in the air separated from the display device (display unit 13) on the three-dimensional model displayed in the display device (display unit 13); and

a feature point extraction unit (depth sensor 14 or camera 15) that recognizes a feature point of workpiece Wk (a side or a vertex of workpiece Wk), in which

the image generation unit (processor 11) generates the display image for displaying the teaching point in a case where a designated position (for example, teaching position Pt11 illustrated in FIG. 3) designated by the aerial operation is designated in the vicinity of the feature point.

With this configuration, MR device DV can support visual confirmation of the teaching position (designated position) by the worker by visualizing the teaching position taught based on the worker's operation to the worker. As a result, MR device DV improves the teaching accuracy of the teaching position even in a case where the teaching position of the teaching point using hand HND and finger FNG of the worker is taught.

### Technology 1-5

The robot teaching system (MR device DV) according to (Technology 4), in which

in a case where the designated position is designated in the vicinity of the feature point by the aerial operation, the image generation unit (processor 11) generates a candidate display image in which each of the designated position and the position of the feature point is displayed,

the output unit (processor 11) displays the candidate display image on the display device (display unit 13),

the detection unit (depth sensor 14 or camera 15) detects the aerial operation performed by the worker on the candidate display image, and

the image generation unit (processor 11) accepts an operation of selecting any one of the designated position and the position of the feature point displayed in the candidate display image by the aerial operation, and generates the display image for displaying the teaching point at the selected designated position or position of the feature point.

With this configuration, MR device DV outputs a position obtained by correcting the teaching position taught based on the worker's operation as a candidate, and causes the worker to select and operate which position is a correct teaching position, so that the teaching position can be easily corrected even in a case where the teaching position (designated position) pointed by hand HND and finger FNG of the worker points to a position deviated from the teaching position desired by the worker. As a result, MR device DV can improve the position accuracy of the teaching position even in a case where the teaching position of the teaching point using hand HND and finger FNG of the worker is taught.

### Technology 1-6

The robot teaching system (MR device DV) according to (Technology 4) or (Technology 5), in which

the detection unit (depth sensor 14 or camera 15) detects a posture of a finger (for example, a thumb, an index finger, a middle finger, a palm, a back of a hand, or the like) of the worker in the air with respect to the three-dimensional model,

the image generation unit (processor 11) generates a posture image (teaching image SC23) for displaying a posture (that is, the posture of virtual welding torch VTC indicating the posture of welding robot RB and the posture of welding torch TC included in welding robot RB) of the robot (welding robot RB) at the designated position designated by a posture of the finger, and

the output unit (processor 11) outputs the posture image to the display device (display unit 13).

With this configuration, even in a case where the position pointed by finger FNG becomes unclear, MR device DV can visualize the teaching position pointed by finger FNG of the worker by displaying teaching image SC21 on which the image “○” indicating teaching position Pt21 is superimposed. As a result, MR device DV can improve the position accuracy of the teaching position even in a case where the teaching position of the teaching point using hand HND and finger FNG of the worker is taught.

### Technology 1-7

A robot teaching method performed by a system (MR device DV) including at least one computer (processor 11), the method including:

storing teaching data (that is, data of teaching information) of a robot (welding robot RB) existing in an actual environment and teaching point data (image data indicating teaching position, for example, data of “○” indicating teaching position Pt11 illustrated in FIG. 3) corresponding to a teaching point used to display the teaching data;

acquiring a relative positional relationship between the actual environment and a display device (display unit 13) that is configured to be mountable to a worker and displays an image to be superimposed on an image of the actual environment or the actual environment itself;

generating a display image (for example, teaching image SC11 illustrated in FIG. 3 and the like) for displaying the teaching point so as to have a predetermined positional relationship with respect to the display device (display unit 13) based on the relative positional relationship and the teaching point data, and outputting the display image to the display device (display unit 13);

detecting an aerial operation that is an operation performed by the worker in an air separated from the display device (display unit 13) on workpiece Wk existing in the actual environment; and

generating the display image for displaying the teaching point and outputting the display image to the display device (display unit 13) in a case where a feature point of the workpiece is recognized and a designated position designated by the aerial operation is designated in the vicinity of the feature point.

With this configuration, even in a case where the position pointed by finger FNG becomes unclear, MR device DV can visualize the teaching position pointed by finger FNG of the worker by displaying teaching image SC21 on which the image “○” indicating teaching position Pt21 is superimposed. As a result, MR device DV can improve the position accuracy of the teaching position even in a case where the teaching position of the teaching point using hand HND and finger FNG of the worker is taught.

### Technology 1-8

A robot teaching method performed by a system (MR device DV) including at least one computer (processor 11), the method including:

storing a three-dimensional model (3D model) of workpiece Wk existing in an actual environment, teaching data (that is, data of teaching information) of a robot (welding robot RB) existing in the actual environment and teaching point data (image data indicating teaching position, for example, data of “○” indicating teaching position Pt11 illustrated in FIG. 3) corresponding to a teaching point used to display the teaching data;

acquiring a relative positional relationship between the actual environment and a display device (display unit 13) that is configured to be mountable to a worker and displays an image to be superimposed on an image of the actual environment or the actual environment itself;

generating a display image (for example, teaching image SC11 illustrated in FIG. 3 and the like) for displaying the three-dimensional model and the teaching point so as to have a predetermined positional relationship with respect to the display device (display unit 13) based on the relative positional relationship, the three-dimensional model, and the teaching point data, and outputting the display image to the display device (display unit 13);

detecting an aerial operation that is an operation performed by the worker in an air separated from the display device (display unit 13) on the three-dimensional model existing in the actual environment; and

generating the display image for displaying the teaching point and outputting the display image to the display device (display unit 13) in a case where a feature point of the workpiece is recognized and a designated position (for example, teaching position Pt11 illustrated in FIG. 3) designated by the aerial operation is designated in the vicinity of the feature point.

With this configuration, even in a case where the position pointed by finger FNG becomes unclear, MR device DV can visualize the teaching position pointed by finger FNG of the worker by displaying teaching image SC21 on which the image “○” indicating teaching position Pt21 is superimposed. As a result, MR device DV can improve the position accuracy of the teaching position even in a case where the teaching position of the teaching point using hand HND and finger FNG of the worker is taught.

### Technology 2-1

A robot teaching system (MR device DV) including:

a teaching data storage unit (memory 12) that stores teaching data (that is, data of teaching information) of a robot (welding robot RB) existing in an actual environment (that is, real world);

a teaching point storage unit (memory 12) that stores teaching point data (image data indicating the teaching position, for example, data of “○” indicating teaching position Pt11 illustrated in FIG. 3) corresponding to a teaching point used to display the teaching data;

a display device (display unit 13) that is configured to be mountable to a worker and displays an image to be superimposed on an image of the actual environment or the actual environment itself; and

a positional relationship acquisition unit (processor 11) that acquires a relative positional relationship between the actual environment and the display device (display unit 13);

an image generation unit (processor 11) that generates a display image (for example, teaching image SC11 illustrated in FIG. 3 and the like) for displaying the teaching point so as to have a predetermined positional relationship with respect to the display device (display unit 13) based on the relative positional relationship and the teaching point data;

an output unit (processor 11) that outputs the display image to the display device (display unit 13); and

a detection unit (depth sensor 14 or camera 15) that detects an aerial operation that is an operation performed by the worker in the air separated from the display device (display unit 13) on workpiece Wk existing in the actual environment, in which in a case where an operation indicating a predetermined direction with respect to the actual environment is executed as the aerial operation, the image generation unit (processor 11) generates the display image (for example, teaching image SC21 illustrated in FIG. 5 and the like) for displaying the teaching point at a position (for example, teaching position Pt21 illustrated in FIG. 5) of an intersection between a virtual axis along the predetermined direction and a surface of the workpiece.

With this configuration, MR device DV can support visual confirmation of the teaching position (designated position) by the worker by visualizing the teaching position taught based on the worker's operation to the worker. As a result, MR device DV improves the teaching accuracy of the teaching position even in a case where the teaching position of the teaching point using hand HND and finger FNG of the worker is taught.

### Technology 2-2

The robot teaching system (MR device DV) according to (Technology 2-1), in which

the detection unit (depth sensor 14 or camera 15) detects a posture of a finger (for example, a thumb, an index finger, a middle finger, a palm, a back of a hand, or the like) of the worker in the air with respect to workpiece Wk,

the image generation unit (processor 11) generates a posture image (teaching image SC23) for displaying a posture (that is, the posture of virtual welding torch VTC indicating the posture of welding robot RB and the posture of welding torch TC included in welding robot RB) of the robot at the designated position designated by a posture of the finger, and the output unit (processor 11) outputs the posture image to the display device (display unit 13).

With this configuration, even in a case where the distance between finger FNG of the worker and teaching position Pt21 taught based on the worker's operation is long and the position pointed by finger FNG becomes unclear, MR device DV can visualize the teaching position pointed by finger FNG of the worker by displaying teaching image SC21 on which the image “○” indicating teaching position Pt21 is superimposed. As a result, MR device DV can improve the position accuracy of the teaching position even in a case where the teaching position of the teaching point using hand HND and finger FNG of the worker is taught.

### Technology 2-3

A robot teaching system (MR device DV) including:

a model storage unit (memory 12) that stores a three-dimensional model (3D model) of workpiece Wk existing in an actual environment (that is, the real world); a teaching data storage unit (memory 12) that stores teaching data (that is, data of teaching information) of a robot (welding robot RB) existing in the actual environment (that is, real world);

a teaching point storage unit (memory 12) that stores teaching point data (image data indicating the teaching position, for example, data of “○” indicating teaching position Pt11 illustrated in FIG. 3) corresponding to a teaching point used to display the teaching data;

a display device (display unit 13) that is configured to be mountable to a worker and displays an image to be superimposed on an image of the actual environment or the actual environment itself; and

a positional relationship acquisition unit (processor 11) that acquires a relative positional relationship between the actual environment and the display device (display unit 13);

an image generation unit (processor 11) that generates a display image (for example, teaching image SC11 illustrated in FIG. 3 and the like) for displaying the three-dimensional model and the teaching point so as to have a predetermined positional relationship with respect to the display device (display unit 13) based on the relative positional relationship, the three-dimensional model, and the teaching point data;

an output unit (processor 11) that outputs the display image to the display device (display unit 13); and

a detection unit (depth sensor 14 or camera 15) that detects an aerial operation that is an operation performed by the worker in the air separated from the display device (display unit 13) on the three-dimensional model displayed in the display device (display unit 13), in which

in a case where an operation indicating a predetermined direction with respect to the actual environment is executed as the aerial operation, the image generation unit (processor 11) generates the display image (for example, teaching image SC21 illustrated in FIG. 5 and the like) for displaying the teaching point at a position (for example, teaching position Pt21 illustrated in FIG. 5) of an intersection between a virtual axis along the predetermined direction and a surface of the workpiece.

With this configuration, MR device DV can support visual confirmation of the teaching position (designated position) by the worker by visualizing the teaching position taught based on the worker's operation to the worker. As a result, MR device DV improves the teaching accuracy of the teaching position even in a case where the teaching position of the teaching point using hand HND and finger FNG of the worker is taught.

### Technology 2-4

The robot teaching system (MR device DV) according to (Technology 2-3), in which

the detection unit (depth sensor 14 or camera 15) detects a posture of a finger (for example, a thumb, an index finger, a middle finger, a palm, a back of a hand, or the like) of the worker in the air with respect to the three-dimensional model,

the image generation unit (processor 11) generates a posture image (teaching image SC23) for displaying a posture (that is, the posture of virtual welding torch VTC indicating the posture of welding robot RB and the posture of welding torch TC included in welding robot RB) of the robot (welding robot RB) at a position of the intersection between a virtual axis along the predetermined direction based on a posture of the finger and a surface of the workpiece, and

the output unit (processor 11) outputs the posture image to the display device (display unit 13).

With this configuration, even in a case where the distance between finger FNG of the worker and teaching position Pt21 taught based on the worker's operation is long and the position pointed by finger FNG becomes unclear, MR device DV can visualize the teaching position pointed by finger FNG of the worker by displaying teaching image SC21 on which the image “○” indicating teaching position Pt21 is superimposed. As a result, MR device DV can improve the position accuracy of the teaching position even in a case where the teaching position of the teaching point using hand HND and finger FNG of the worker is taught.

### Technology 2-5

A robot teaching method performed by a system (MR device DV) including at least one computer (processor 11), the method including:

storing teaching data (that is, data of teaching information) of a robot (welding robot RB) existing in an actual environment and teaching point data (image data indicating teaching position, for example, data of “○” indicating teaching position Pt11 illustrated in FIG. 3) corresponding to a teaching point used to display the teaching data;

acquiring a relative positional relationship between the actual environment and a display device (display unit 13) that is configured to be mountable to a worker and displays an image to be superimposed on an image of the actual environment or the actual environment itself;

generating a display image (for example, teaching image SC11 illustrated in FIG. 3 and the like) for displaying the teaching point so as to have a predetermined positional relationship with respect to the display device (display unit 13) based on the relative positional relationship and the teaching point data, and outputting the display image to the display device (display unit 13);

detecting an aerial operation that is an operation performed by the worker in an air separated from the display device (display unit 13) on workpiece Wk existing in the actual environment; and

generating and outputting, in a case where an operation indicating a predetermined direction with respect to the actual environment is executed as the aerial operation, the display image (for example, teaching image SC21 illustrated in FIG. 5 and the like) for displaying the teaching point at a position (for example, teaching position Pt21 illustrated in FIG. 5) of an intersection between a virtual axis along the predetermined direction and a surface of the workpiece to the display device (display unit 13).

With this configuration, even in a case where the distance between finger FNG of the worker and teaching position Pt21 taught based on the worker's operation is long and the position pointed by finger FNG becomes unclear, MR device DV can visualize the teaching position pointed by finger FNG of the worker by displaying teaching image SC21 on which the image “○” indicating teaching position Pt21 is superimposed. As a result, MR device DV can improve the position accuracy of the teaching position even in a case where the teaching position of the teaching point using hand HND and finger FNG of the worker is taught.

### Technology 2-6

A robot teaching method performed by a system (MR device DV) including at least one computer (processor 11), the method including:

storing a three-dimensional model (3D model) of workpiece Wk existing in an actual environment, teaching data (that is, data of teaching information) of a robot (welding robot RB) existing in the actual environment, and teaching point data (image data indicating teaching position, for example, data of “○” indicating teaching position Pt11 illustrated in FIG. 3) corresponding to a teaching point used to display the teaching data;

acquiring a relative positional relationship between the actual environment and a display device (display unit 13) that is configured to be mountable to a worker and displays an image to be superimposed on an image of the actual environment or the actual environment itself;

generating a display image (for example, teaching image SC11 illustrated in FIG. 3 and the like) for displaying the three-dimensional model and the teaching point so as to have a predetermined positional relationship with respect to the display device (display unit 13) based on the relative positional relationship, the three-dimensional model, and the teaching point data, and outputting the display image to the display device (display unit 13);

detecting an aerial operation that is an operation performed by the worker in an air separated from the display device (display unit 13) on the three-dimensional model existing in the actual environment; and generating and outputting, in a case where an operation indicating a predetermined direction with respect to the actual environment is executed as the aerial operation, the display image (for example, teaching image SC21 illustrated in FIG. 5 and the like) for displaying the teaching point at a position (for example, teaching position Pt21 illustrated in FIG. 5) of an intersection between a virtual axis along the predetermined direction and a surface of the workpiece to the display device (display unit 13).

With this configuration, even in a case where the distance between finger FNG of the worker and teaching position Pt21 taught based on the worker's operation is long and the position pointed by finger FNG becomes unclear, MR device DV can visualize the teaching position pointed by finger FNG of the worker by displaying teaching image SC21 on which the image “○” indicating teaching position Pt21 is superimposed. As a result, MR device DV can improve the position accuracy of the teaching position even in a case where the teaching position of the teaching point using hand HND and finger FNG of the worker is taught.

Although various exemplary embodiments have been described above with reference to the accompanying drawings, the present disclosure is not limited to such examples. It is apparent that those skilled in the art can conceive various modification examples, correction examples, substitution examples, addition examples, deletion examples, and equivalent examples within the scope described in the attached claims, and those examples are understood to be within the technical scope of the present disclosure. In addition, the constituent elements in the above-described various exemplary embodiments may be arbitrarily combined without departing from the gist of the disclosure.

The present disclosure is useful as a robot teaching system and a robot teaching method that support teaching of a teaching point at a position where direct teaching is difficult using fingers of a worker, a marker pen, or the like.

What is claimed is:

1. A robot teaching system comprising:
a teaching data storage unit that stores teaching data for a robot existing in an actual environment;
a teaching point storage unit that stores teaching point data corresponding to a teaching point used to display the teaching data;
a display device that is mountable to a worker and displays an image to be superimposed on an image of the actual environment or the actual environment itself;
a positional relationship acquisition unit that acquires a relative positional relationship between the actual environment and the display device;
an image generation unit that generates a display image for displaying the teaching point so as to have a predetermined positional relationship with respect to the display device based on the relative positional relationship and the teaching point data;
an output unit that outputs the display image to the display device; and
a detection unit that detects an aerial operation that is an operation performed on a workpiece existing in the actual environment by the worker in an air separated from the display device, wherein
in a case where an operation indicating a predetermined direction with respect to the actual environment is executed as the aerial operation, the image generation unit generates the display image for displaying the teaching point at a position of an intersection between a virtual axis along the predetermined direction and a surface of the workpiece.

2. The robot teaching system according to claim 1, wherein
the detection unit detects a posture of a finger of the worker in the air with respect to the workpiece,
the image generation unit generates a posture image for displaying a posture of the robot at a position of the intersection between a virtual axis along the predetermined direction based on a posture of the finger and a surface of the workpiece, and
the output unit outputs the posture image to the display device.

3. A robot teaching system comprising:
a model storage unit that stores a three-dimensional model of a workpiece existing in an actual environment;
a teaching data storage unit that stores teaching data for a robot existing in the actual environment;
a teaching point storage unit that stores teaching point data corresponding to a teaching point used to display the teaching data;
a display device that is mountable to a worker and displays an image to be superimposed on an image of the actual environment or the actual environment itself;
a positional relationship acquisition unit that acquires a relative positional relationship between the actual environment and the display device;
an image generation unit that generates a display image for displaying the three-dimensional model and the teaching point so as to have a predetermined positional relationship with respect to the display device based on the relative positional relationship, the three-dimensional model, and the teaching point data;
an output unit that outputs the display image to the display device; and
a detection unit that detects an aerial operation that is an operation performed on the three-dimensional model displayed in the display device by the worker in an air separated from the display device, wherein
in a case where an operation indicating a predetermined direction with respect to the actual environment is executed as the aerial operation, the image generation unit generates the display image for displaying the teaching point at a position of an intersection between a virtual axis along the predetermined direction and a surface of the workpiece.

4. The robot teaching system according to claim 3, wherein
the detection unit detects a posture of a finger of the worker in the air with respect to the three-dimensional model,
the image generation unit generates a posture image for displaying a posture of the robot at a position of the intersection between a virtual axis along the predetermined direction based on a posture of the finger and a surface of the workpiece, and
the output unit outputs the posture image to the display device.

5. A robot teaching method performed by a system including at least one computer, the method comprising:
storing teaching data of a robot existing in an actual environment and teaching point data corresponding to a teaching point used to display the teaching data;
acquiring a relative positional relationship between the actual environment and a display device that is mountable to a worker and displays an image to be superimposed on an image of the actual environment or the actual environment itself;
generating a display image for displaying the teaching point so as to have a predetermined positional relationship with respect to the display device based on the relative positional relationship and the teaching point data, and outputting the display image to the display device;
detecting an aerial operation that is an operation performed by the worker in an air separated from the display device on a workpiece existing in the actual environment; and
in a case where an operation indicating a predetermined direction with respect to the actual environment is executed as the aerial operation, generating the display image for displaying the teaching point at a position of an intersection between a virtual axis along the predetermined direction and a surface of the workpiece, and outputting the display image to the display device.

6. A robot teaching method performed by a system including at least one computer, the method comprising:
storing a three-dimensional model of a workpiece existing in an actual environment, teaching data of a robot existing in the actual environment, and teaching point data corresponding to a teaching point used to display the teaching data;
acquiring a relative positional relationship between the actual environment and a display device that is mountable to a worker and displays an image to be superimposed on an image of the actual environment or the actual environment itself;
generating a display image for displaying the three-dimensional model and the teaching point so as to have a predetermined positional relationship with respect to the display device based on the relative positional relationship, the three-dimensional model, and the teaching point data, and outputting the display image to the display device;
detecting an aerial operation that is an operation performed by the worker in an air separated from the display device on the three-dimensional model existing in the actual environment; and
in a case where an operation indicating a predetermined direction with respect to the actual environment is executed as the aerial operation, generating the display image for displaying the teaching point at a position of an intersection between a virtual axis along the predetermined direction and a surface of the workpiece.
